(19) United States
(12) Patent Application Publication
(10) Pub. No.: US 2002/0052700 A1
(43) Pub. Date: May 2, 2002

(54) Method and apparatus for identifying deformation of a moving sheet

(75) Inventor: John Shakespeare, Siuro (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Metso Paper Automation Oy, Tampere (FI)

(21) Appl. No.: 09/915,019

(22) Filed: Jul. 25, 2001

Related U.S. Application Data
(63) Continuation of application No. PCT/FI00/00076, filed on Feb. 3, 2000.

(30) Foreign Application Priority Data
Feb. 4, 1999 (FI) 990217

(51) Int. Cl. G01B 5/28

(52) U.S. Cl. 702/35

(57) ABSTRACT

The present invention provides a method and apparatus for identifying deformation of a moving sheet. In the present invention, the periodicity of original periodic or nearly periodic markings initially caused on the sheet is determined. Thereafter, a Fourier image of periodic markings of the sheet as it is moved along a path is produced with an imaging device using a Fourier transform optical element. The appropriate peaks of the Fourier image corresponding to the markings of the sheet are located, and the deformation of the sheet is calculated by comparing the measured peaks of the Fourier image to the known initial periodicity of the markings.

### CROSS-REFERENCE TO RELATED APPLICATIONS

This application is a continuation application of PCT Patent Application No. PCT/FI00/00076 filed on Feb. 3, 2000, which claims priority from Finnish Application No. 990217 filed on Feb. 4, 1999, the contents of which are incorporated in their entirety herein.

### FIELD OF THE INVENTION

The present invention relates to an apparatus and method for use in an industrial process, and more particularly, the invention relates to an apparatus and method for identifying deformation of a sheet moving along a path.

### BACKGROUND OF THE INVENTION

Usually in a paper making process, the manufactured sheet neither shrinks nor stretches in the plane of its movement during passage through the forming unit and presses. However, it usually stretches in the machine direction (direction of movement, or MD), and shrinks in the cross-machine direction (direction in the plane of movement perpendicular to the direction of movement, or CD) during drying operations. The MD stretching is a natural consequence of the tension, which must be applied in the direction of movement during drying. The shrinkage is partly due to the natural contraction of cellulosic fibers when dried, and partly due to transverse tensions induced by the machine direction tension. The deformations in MD and CD are usually non-uniform across the sheet.

Knowledge of the CD shrinkage profile is particularly advantageous in forming mapping relations between cross-machine actuators and measured sheet properties. In particular, when the shrinkage profile is not uniform, efficacy of profile control may depend critically on the accuracy of shrinkage profile information. Methods for calculating mapping profiles from shrinkage profiles are well known to those skilled in the art of paper machine profile control. Knowledge of the MD stretching profile is similarly advantageous in control of the tension profile of the sheet, in avoiding sheet breaks, and in troubleshooting process problems.

A large number of prior art solutions in this field require that the CD shrinkage profile be identified by deliberately disturbing the sheet-making process for that purpose, or by observing the effects of disturbances caused for other reasons. Typical methods whereby actuators are modulated differentially across the machine, and responses in sheet properties subsequently measured are disclosed in U.S. Pat. Nos. 5,122,963, 5,400,258 and 5,539,634. In these disclosures, it is necessary to disturb the paper making process at known locations in the cross machine direction, to measure the cross-machine locations of consequent disturbances in paper properties, and to deduce the cross-machine shrinkage profile therefrom.

None of these disclosures, however, provides an estimate of the MD stretching profile. They also provide relatively slow estimates of the CD shrinkage profile, since each relies on measuring the effect of a stimulus in a noisy profile measurement, which is subject to other causes of variation. Thus, these methods require much filtering and other signal processing, often relying on sophisticated calculations. Moreover, since they rely on identification of the positions of relatively large scale features, it is possible in practice to measure only a few positions at a time, so that only a broad-scale CD shrinkage profile can be identified.

A paper by K. R. Wadhams et al. entitled “The measurement of differential CD shrinkage,” Paper Technology, p. 36-38, January 1991 discloses a method for identifying the MD and CD deformation profiles at high resolution. In the method images of periodic marks, for example wire marks, of small areas across the sheet are formed using a charge-coupled device such as a CCD camera. The resulting digital images are processed using two-dimensional Fourier transforms and identifying the MD and CD deformations from the computed periodicities in MD and CD. The deformations in each axis are trivially calculated from the wavelengths for which peaks occur in the Fourier coefficients, in relation to the known periodicities of the original marks. However, this technique requires significant computational resources, since images must be acquired, stored, and processed at high resolution. These constraints lead to slow operation and high cost, rendering the technique interesting, but impractical.

European Patent No. EP 0 689 046 discloses a method where Fourier optics is used for the detection of defects or deviations from exact regularity of a woven fabric. The method of this patent determines the presence of irregular defects by the amount of spectral energy distributed between the peaks of the Fourier image. It also determines deviations of a measured regular pattern from a target regular pattern by subtracting their Fourier images. However, the method of EP 0 689 046 can not be used for identifying deformation of a moving sheet.

### SUMMARY OF THE INVENTION

In light of the above noted shortcomings with conventional methods and system, the present invention provides apparatus and methods that provide an improved method for identifying deformation of a sheet moving along a path having markings initially caused thereon.

The method of the present invention includes the following steps:

(i) determining the periodicity of the markings initially caused on the sheet;

(ii) producing a Fourier image of the markings on the sheet as the sheet moves along the path down stream from a position where the markings were initially caused on to the sheet, wherein said producing step uses an imaging device having a Fourier transform optical element to produce the Fourier image;

(iii) locating appropriate peaks of the Fourier image corresponding to the markings on the sheet; and

(iv) calculating the deformation of the sheet as it moves along the path by comparing the measured peaks of the Fourier image to the initial periodicity of the markings.

The nonuniformity of deformation of the sheet may be determined by repeating steps (i), (ii), (iii), and (iv), for example, for each part of the sheet which is of interest. If the original periodicity is known to be the same across the whole sheet, then only steps (ii), (iii) and (iv) need be repeated. In particular, by determining the local deformation of the sheet at plural locations across the sheet according to this method, profiles of MD and CD shrinkage of the sheet may be determined.

Further, the apparatus of the present invention includes:

means for determining the periodicity of the markings initially cause on the sheet;

a Fourier transform optical element and an imaging device for producing a Fourier image of the markings on the sheet as the sheet moves along the path down stream from a position where the markings were initially applied to the sheet;

means for locating the appropriate peaks of the Fourier image corresponding to the markings on the sheet; and

means for calculating deformation of the sheet as it moves along the path by comparing the measured peaks of the Fourier image to the initial periodicity of the markings.

An important aspect of the present invention is that the periodicity of original periodic or nearly periodic markings caused to the sheet is determined, and a Fourier image of periodic markings of the processed moving sheet is produced with an imaging device using a Fourier transform optical element. The appropriate peaks of the Fourier image corresponding to the markings of the sheet are located. The deformation of the sheet is calculated by comparing the measured peaks of the Fourier image to the known original markings.

The apparatus of the present invention may further comprise means for causing the above means to perform said Fourier imaging, peak locating, and calculation at each part of the sheet which is of interest, and thus determining nonuniformity of sheet deformation. This may be accomplished for example by means of apparatus which physically traverses the sheet, or which optically scans across the sheet, or by deployment of plural apparatuses at different locations across the moving sheet.

An advantage of the invention is that the deformation can be identified without disturbance to the process. Further, the identification can be carried out by direct measurement with minimal need for computation, which may allow for avoidance of storage and processing of images and consequently may result in savings in cost and complexity of the device. The invention also may allow avoidance of any delays due to limited speed of computation. Further, the deformation of the sheet can be determined on line with higher resolution than in prior art. In contrast to prior art techniques, the present invention allows the deformation of the sheet to be determined promptly at any time, or continuously. The changes in the deformation of the sheet can typically be detected more rapidly than with prior art techniques.

A further advantage of the invention is that it provides a means of detecting periodicities due to process equipment defects or improper operation of process equipment. This is beneficial in troubleshooting process problems, as each device in a papermaking process tends to produce a characteristic periodicity.

### BRIEF DESCRIPTION OF THE DRAWINGS

Having thus described the invention in general terms, reference will now be made to the accompanying drawings, which are not necessarily drawn to scale, and wherein:

FIG. 1 is a schematic side view of a typical paper making process.

FIG. 2 is a schematic side view of an apparatus according to one embodiment of the present invention.

FIG. 3 is a schematic side view of an apparatus according to alternative embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

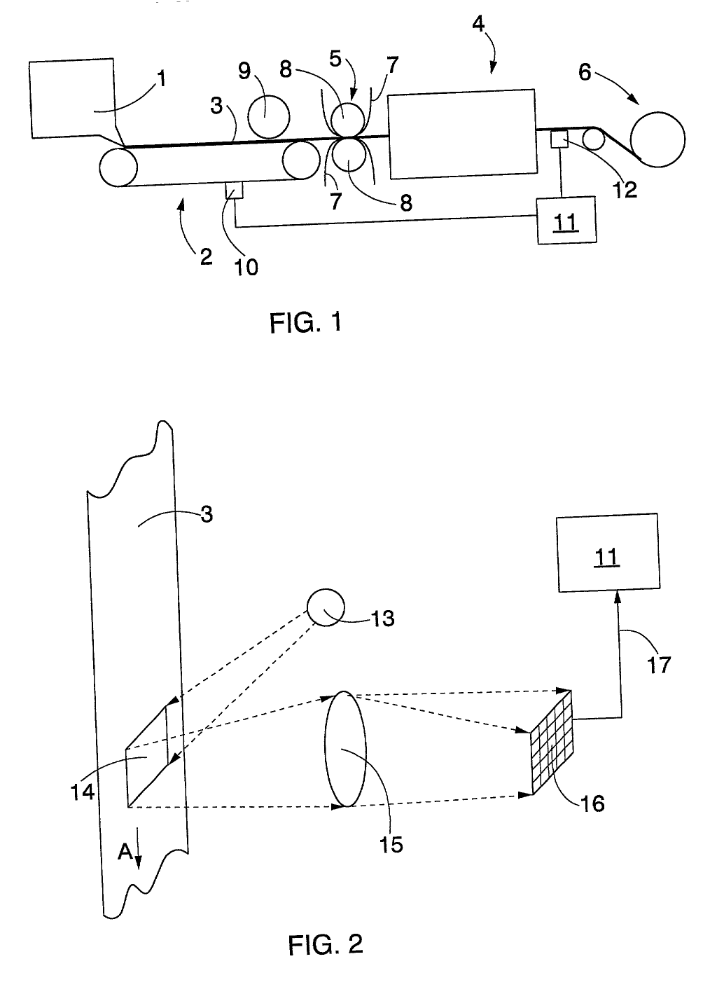

FIG. 1 is a schematic side view of a paper machine with which the apparatus and method of the present invention may be implemented. Paper and paper board and tissue manufacturing processes are examples of processes for making a moving sheet the deformation of which is identified according to the invention. The paper machine of FIG. 1 comprises a headbox 1, from which pulp is fed into a former 2, where a fiber web 3 is formed of the pulp. After the former 2, the fiber web 3 is led to a drying apparatus 4. A press 5 may be provided between the former 2 and the drying apparatus 4. After the drying apparatus 4, the fiber web is led to a reel 6. The paper machine may further comprise, for example, size presses, calendar or coating units, which are not illustrated in the accompanying figure for the sake of clarity.

In the former 2, a moving wire of a forming fabric 7 is commonly used to drain much of the water from a pulp suspension. Other fabrics 7 are commonly used to transport the partly dried pulp sheet through presses 5 and dryers 4, which remove most of the remaining water, thus producing paper.

The fabric 7 usually leaves a slight imprint of its surface weave pattern on the side of the sheet that was in contact with it. These periodic markings are of relatively small scale (often less than 1 mm), reflecting the pitch of warp and weft or other weave pattern on the wire, which usually differ. In twin wire machines both surfaces may receive such imprints, (not necessarily the same imprints). Periodic markings of a different, usually larger scale may be imposed by grooved rolls 8 in the presses 5, or by special dandy rolls 9 in contact with the forming unit 2.

Periodic marks may also appear due to hydrodynamic effects in the headbox 1. In this case, the periodicities are related to details of the headbox 1 construction, such as the pitch of tubes in each layer of the turbulence generator and the arrangement pattern of multiple layers of such tubes. In some cases, these marks may be present to some extent in the sheet under all operating conditions, while in others the presence may be indicative of improper headbox operation. Markings caused in this way are normally at the scale of 1 cm or less and are not stationary in the CD. Thus, they are typically of too small a scale to be detected by conventional profile measurements, which usually can resolve only stationary features with wavelengths of 2 cm or larger.

Local markings of an aperiodic, nearly periodic, or periodic nature may be caused by defective, worn, damaged, or malfunctioning equipment. For instance, ripples may be caused over a part of the pulp suspension in the forming section as a result of a scratch to the headbox slice lip or slice apron, or as a result of a notch or similar damage to or abrasion of a drainage element under the wire. Such ripples in the pulp suspension result in markings to the sheet, which generally are local, with periodicity that varies with machine speed. The periodicities of these markings are generally unrelated to the fixed periodicities due to fabrics and tubes described above.

The periodicity of the original marks is determined for example by measuring the surface weave pattern of the fabric 7 with a first measuring device 10. In some cases, the periodicity of the original markings is known a priori and is known to be invariant in operation. For example, the pitch and pattern of tubes in a headbox is known and constant. Alternatively, if a paper machine employs a known type of forming fabric, and the stretching of that fabric is measured while in use, then the periodicities of its warp and weft can be calculated a priori from the fabric specifications and the measured degree of stretching. If the periodicity of the original markings is known a priori the device 10 is not needed and may be dispensed with without departing from the present invention. The periodicity of the original marks is led to a processing unit 11. The Fourier coefficients of periodic marking on the fiber web's 3 surface are measured with a second measuring device 12, thus producing a Fourier image of the web's 3 surface. Deformation in MD and CD can then be calculated. For example, local CD shrinkage is:

$${S}_{CD} ( x ) = \frac{{λ}_{meas} ( x )}{{λ}_{orig} ( x )}$$

where S_{CD} is the shrinkage ratio, λₘₑₐₛ is the measured periodicity wavelength and λ_{orig} is the original periodicity wavelength, all at CD coordinate x.

FIG. 2 illustrates one embodiment of an apparatus according to the present invention. With regard to FIG. 2, a lamp 13 is provided that illuminates an imaged area 14 of a sheet or paper web 3 that moves in a direction described with arrow A. The invention uses a Fourier transform optical element 15 in combination with an imaging device 16 to provide a direct measurement of the Fourier coefficients 17 of periodic markings on the sheet surface. Thus, the measured image is of the Fourier coefficients 17 rather than of the sheet surface. The Fourier transform optical element 15 can be, for example, a Fourier lens. The imaging device 16 is any sort of apparatus capable of forming a digital representation of the Fourier image. For example, the imaging device 16 could be a CCD-camera forming a digital image directly, e.g. a CCD array, or it could be a digital video camera forming a digital signal serializing the image, e.g. a CCD raster. Further, the imaging device 16 could form an analog image that can be subsequently digitized, for example, by using a photograph and a scanner or form an analog signal serializing the image that can later be digitized like when using an analog video camera. Additional analog signal processing could take place before digitizing the analog images. Additional digital signal processing, including image processing, could take place after the digital representation of the Fourier image is obtained. A Fourier lens 15 and imaging device 16 can measure the CD Fourier coefficients 17 or the MD Fourier coefficients 17 using an appropriately aligned lens 15 and linear imaging device 16. Alternatively both the CD coefficients 17 and the MD coefficients 17 can be measured using an appropriately aligned lens 15 and planar imaging device 16.

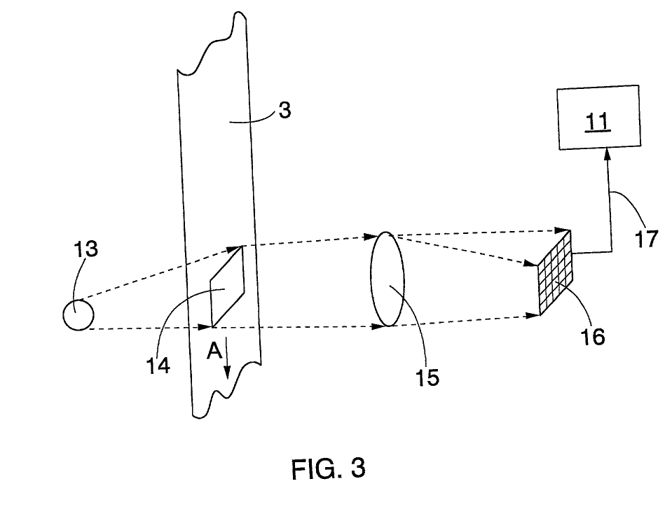

FIG. 3 depicts an alternative arrangement of the apparatus of the invention, wherein the light from the lamp 13 illuminates the imaged area 14 of the sheet or paper web 3 from behind instead of from the front as in FIG. 2. The components and functions depicted in FIG. 3 are otherwise the same as those depicted in FIG. 2 and described above. Other beneficial geometries and combinations of apparatus will be obvious to those skilled in the art, such as by providing both front and rear illumination alternatively, or by providing imaging components on both sides of the sheet with illumination from one side.

Since the Fourier coefficients 17 are measured directly, it remains only to locate appropriate peaks of the Fourier image corresponding to the markings of interest. Since the periodicities of said markings are known, the peaks can be found with minimal computational effort.

The Fourier lens 15 is preferably chosen to produce a Fourier image over at least the range of scales over which the periodicities of interest might reasonably vary. These scales may differ in the MD and CD axes.

The dimensions of the imaging device 16 are preferably chosen to measure the range of coefficients 17 of interest in the Fourier image. The spatial resolution of the imaging device 16 should be sufficient to allow detection of variations in periodicity which are significant for purposes of identifying the sheet deformation. The wavelength of light used to illuminate the sheet is preferably chosen to produce a clear Fourier image at the scales of interest, and need not be visible light. For measurements made on a moving paper web, infrared wavelengths are typically preferred.

In the present invention, the Fourier transform optics is used for identifying particular markings of a variable periodic or nearly periodic nature on a moving sheet during manufacture, and especially for inferring CD and MD deformation by comparing the measured local periodicity with a known initial periodicity. For example, the wire mark is almost always present in the paper web and its initial periodicity is fixed and known. The apparatus of the invention is concerned only with the positions of particular peaks in the Fourier image and typically does not care about the amount of spectral energy between the peaks. A variation in local periodicity is expected since the paper web shrinks non-uniformly in CD and stretches non-uniformly in MD during manufacture. Additionally, peaks that are observed at unexpected wavelengths, either locally or across the sheet, may be due to problems with process equipment or operation of equipment. The wavelengths of these peaks and their variation in wavelength or amplitude across the sheet can be used in process troubleshooting or process control.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for identifying deformation of a sheet moving along a path having markings initially caused thereon in a substantially periodic pattern, said method comprising the steps of:
determining the periodicity of the markings initially caused on the sheet;
producing a Fourier image of the markings on the sheet as the sheet moves along the path downstream from a position where the markings were initially caused on the sheet, wherein said producing step uses an imaging device having a Fourier transform optical element to produce the Fourier image;
locating appropriate peaks of the Fourier image corresponding to the markings on the sheet; and
calculating the deformation of the sheet as it moves along the path by comparing the measured peaks of the Fourier image to the initial periodicity of the markings.

2. A method according to claim 1, wherein said producing step produces a Fourier image of the markings of a selected portion of the sheet and said calculating step calculates deformation of the sheet at the selected portion of the sheet.

3. A method according to claim 2, wherein said producing step produces individual Fourier images of the markings at a plurality of selected portions of the sheet and said calculating step calculates a deformation value for each of the plurality of selected portions of the sheet.

4. A method according to claim 1, wherein said producing step uses a CCD camera to produce a Fourier image of the markings on the sheet.

5. A method according to claim 1 further comprising the step of providing a sheet in the form of a fiber web selected from the group consisting of paper, paper board and tissue web.

6. A method according to claim 1, wherein said producing step produces a Fourier image of the markings on the sheet using an imaging device having a Fourier lens.

7. A method according to claim 1, further comprising the step of illuminating the sheet to thereby create an image of the markings on the sheet, and wherein said producing step uses the image to produce a Fourier image of the markings.

8. A method according to claim 7, wherein said illuminating step illuminates the sheet with infrared light.

9. An apparatus for identifying deformation of a sheet moving along a path having markings initially caused thereon in a substantially periodic pattern, said apparatus comprising:
means for determining the periodicity of the markings initially caused on the sheet;
a Fourier transform optical element and an imaging device for producing a Fourier image of the markings on the sheet as the sheet moves along the path downstream from a position where the markings were initially caused on the sheet;
means for locating the appropriate peaks of the Fourier image corresponding to the markings on the sheet; and
means for calculating deformation of the sheet as it moves along the path by comparing the measured peaks of the Fourier image to the initial periodicity of the markings.

10. An apparatus according to claim 9, wherein said Fourier transform optical element and imaging device are arranged to produce a Fourier image of markings of a selected portion of the sheet and said means for calculating deformation of the sheet calculates deformation of the sheet at the selected portion of the sheet.

11. An apparatus according to claim 10, wherein said Fourier transform optical element and imaging device are arranged to produce individual Fourier images of the markings on the sheet at a plurality of selected portions of the sheet and said means for calculating deformation of the sheet calculates a deformation value for each of the plurality of selected portions of the sheet.

12. An apparatus according to claim 9, wherein said imaging device is a CCD camera.

13. An apparatus according to claim 9, wherein the sheet is in the form of a fiber web selected from the group consisting of paper, paper board and tissue web.

14. An apparatus according to claim 9, wherein said Fourier transform optical element is a Fourier lens.

15. An apparatus according to claim 9 further comprising means for illuminating the sheet to thereby create an image of the markings on the sheet used by said Fourier transform optical element and imaging device to produce a Fourier image of the markings on the sheet.

16. An apparatus according to claim 15, wherein said means for illuminating the sheet produces an infrared light for illuminating the sheet.
